(19) United States
(12) Patent Application Publication
(10) Pub. No.: US 2018/0341686 A1
(43) Pub. Date: Nov. 29, 2018

(54) SYSTEM AND METHOD FOR DATA SEARCH BASED ON TOP-TO-BOTTOM SIMILARITY ANALYSIS

(71) Applicant: Nanfang HU, Palo Alto, CA (US)

(72) Inventor: Nanfang HU, Palo Alto, CA (US)

(21) Appl. No.: 15/606,173

(22) Filed: May 26, 2017

(51) Int. Cl. G06F 17/30; G06N 99/00

(52) U.S. Cl. CPC G06F 17/30528; G06N 99/005

(57) ABSTRACT

A method and system for performing searching based on a top-to-bottom feature space analysis may be disclosed. Such a method may include training a mapping model, calculating a signature and centroid of a data block, and generating a list of search results corresponding to data blocks based on the similarity or distance of the centroids of each of said data blocks to the query vector. Data may be subject to data cleaning, which may include, for example, noise removal and transformation to a unifying format, in order to ensure that a centroid is accurately generated. Search results may be based on a predetermined topic or subtopic, or may be based on a keyword or similarity query from the user, as may be desired.

### BACKGROUND

The organization of information has been an ever-present challenge throughout human history. The widespread proliferation of books necessitated the creation of a library system which could be used to classify them. Books were most often classified manually, typically based on their subject and then on their author.

The Internet brought these challenges to the digital age. On the Internet, information is conveniently presented in a digital data format. As such, many of the first search engines developed in the early days of the Internet took a traditional approach, such as that described above, to digital web content. For instance, the YAHOO search engine, as initially deployed, tried to rely on manual classification of sites or other content by content type. However, with the growth of the Internet, the volume of content that must be classified, and the size and complexity of the content, have each grown rapidly beyond the ability of a search engine to perform manual classification with any effectiveness.

A breakthrough made by the GOOGLE search engine was to index individual data blocks, using key words, along with some usage statistics that could be used to rank the information. However, as internet technology evolves, a huge amount of new information or data is published daily, and finding useful information is still a time-consuming and difficult task.

Inventors and companies have persistently attempted to find new directions or solutions that could be used to handle this issue. A wide variety of approaches to this problem are reflected in the art.

For example, U.S. Pat. No. 6,618,727, for a “system and method for performing similarity searching,” is directed to a computer-implemented method that can be used to detect and score similarities between documents in a source database and a search criteria. Specifically, it uses a hierarchy of parent and child categories, with each of the child categories being under a parent category. Child object scores are computed for each child object, and a parent object score is computed from the child object scores.

In another example, U.S. Pat. No. 7,440,947, for a “system and method for identifying query-relevant keywords in documents with latent semantic analysis,” is directed to a system and method for searching that analyzes documents to identify keywords relevant to a query by the use of semantic analysis. Documents can be represented by a document term matrix containing one or more term-weight vectors, which may be term-frequency vectors or may be inverse-document-frequency vectors calculated from the term frequencies. Search terms are represented by vectors which are compared to candidate document vectors.

In another example, U.S. Pat. No. 6,542,889, for “methods and apparatus for similarity text search based on conceptual indexing,” is directed to a method of performing conceptual similarity searches. Such a method requires generating one or more conceptual word-chains from one or more documents that are to be used in the conceptual similarity search, building a conceptual index of documents with the one or more word-chains, and evaluating a similarity query using the conceptual index.

In another example, U.S. Pat. No. 8,266,150, for a “scalable document signature search engine,” is directed to a document signature index and search system. A signature index, which may include search tables, may be defined. The system may further include an index engine and a search engine. The index engine may provide a weak or a strong searching index to the search engine, and the search engine may accordingly perform a weak or a strong search based on the index that is provided.

In these and in other solutions, data blocks may be vectorized; for example, as discussed in U.S. Pat. No. 7,440,947, documents or other contents of a data block may be transformed into a vector, which may contain, for example, terms that are of relevance to the particular data block in question. Once two data blocks have been vectorized, they may be compared by a vector comparison technique to determine their similarity or distance. When the vectors have a larger similarity value, this typically means that the content of the two data blocks is similar, while when the vectors have a smaller similarity value, this typically means that the content of the two data blocks is dissimilar.

As indicated, in contrast to library index or catalog systems, such as are used to manage books, clustering methods have been widely studied as methods for organizing digital content.

However, these and other solutions that have been developed all have downsides. Essentially all existing solutions have focused on individual data blocks, and have used various methods—such as, for example, key words, hashing, digital signatures, indexing, and the like—to try to extract core features of individual data blocks. However, once these features have been extracted, it then becomes extremely difficult to correlate them among all of the data blocks of a huge set of data in any meaningful way. For example, it is often technically impossible to apply a vector comparison technique to all of the vectors (each vector having hundreds or thousands of features) in a particular data set, which may include millions of documents or other content files. This poor scalability typically results in the solutions becoming less and less effective as the size of the data set increases. These existing solutions, which focus on conducting analysis data block by data block, can be understood as something of a “bottom-to-top” approach.

### SUMMARY

An alternative approach to conducting similarity analysis may be understood, which may function in the opposite manner from the solutions previously discussed. In particular, rather than relying on the application of a “bottom-to-top” approach, a “top-to-bottom” approach may instead be contemplated. In such an approach, a number of models may be built by utilizing a large collection of data. Based on these models, a similarity analysis may be used to cluster the data or digital contents. Such an approach may be facilitated, where possible, by the application of artificial intelligence and machine deep learning.

According to an exemplary embodiment of an approach for conducting similarity analysis, a large set of related data blocks may be collected. Each of these data blocks may be broken down further into small cells. These cells may be different based on the content of the data block, and a variety of different types of cells may exist. For example, Web pages or other documents may be broken down into word or phrase cells; images or videos may be broken down into pixels, or blocks of pixels, and colors; and music or other sounds may be broken down into cells storing pitches, durations, volume, timbre, and the like. Other types of cells, for these or other types of data, may also be contemplated.

For a large number of cells, the statistical behaviors of different cells may be studied. In particular, a variety of statistical properties may be evident from the collection of the cells, or the collection of similar data blocks from which the cells are generated. From these statistical properties, a data structure, called a signature, may be derived for a single data block or a set of data blocks.

Based on direct analysis of a large collection of data blocks, a model may be built which may be used to map an individual cell in a data block signature to a vector in N-dimensional space, or “feature space.” In feature space, original cells may be vectorized, and their core behaviors (such as text syntax) may be maintained. In some embodiments, a data block may be represented as a vector by using a weighted combination of individual cell vectors. This weighted combination may be called a “centroid” of the data block in N-dimensional space. Therefore, further similarity analysis becomes possible by using data block centroids. In a similar manner, a centroid can be calculated for a set of data blocks. In an exemplary embodiment, a centroid calculated for a set of data blocks may be used to cluster data blocks or documents having the same topic or subject.

The similarity between any two data blocks may be measured in N-dimensional space by, in some exemplary embodiments, calculating the distance between two vectors or the cosine similarity of two vectors.

In particular, an exemplary method for performing searching by top-to-bottom similarity analysis, which may be implemented by an exemplary system, may include the following steps. First, a plurality of related data blocks may be collected. Next, the blocks may be broken into a plurality of cells, each including at least one data segment. Next, one or more cells may be identified that may be undesirable to keep as part of the data set (for example, stop words), which may be those cells with a high occurrence and which have either a low amount of contribution to a final subject or which make up a data block feature that it is unnecessary to analyze. The one or more undesirable cells may be removed, to leave a plurality of remaining cells.

One or more statistical metrics may then be calculated for the plurality of remaining cells, which may include, for example, a frequency value of data segments in the plurality of cells. A frequency threshold may then be designated for data segments in the plurality of cells, which may be set (all cells over a certain frequency, or the like) or may be variable (top 5 most frequent cells, or the like). Cells having data segments under the frequency threshold may be removed, leaving a plurality of high-frequency cells. A block signature may be calculated, which may include the plurality of high-frequency cells and the frequency values.

In an exemplary embodiment, the method may proceed by receiving a search query of one or more keywords, mapping the search query to a query vector in the feature space, measuring the similarity or distance to each data block; and identifying one or more data blocks in the plurality of related data blocks having the highest similarity values, and displaying the one or more data blocks with the highest similarity values. This may be, for example, a static or dynamic list; for example, a user may be shown the top 5 or top 10 (or top N) most relevant results, may be shown all relevant results above a particular similarity score, may be able to change the number of results shown, or may otherwise be able to customize the output. This approach may be called a “key word similarity search.”

In an exemplary embodiment, the method may proceed by receiving a search query of one or more keywords. According to the embodiment, a query of one or more common key words may be received, which may be used to collect a number of data blocks or documents. The data block signatures and/or centroids of these data blocks or documents may be combined in order to form a query centroid. The method may then proceed by measuring the similarity or distance to each data block from the query centroid, and identifying one or more data blocks in the plurality of related data blocks having the highest similarity values, and displaying the one or more data blocks with the highest similarity values. This may be, for example, a static or dynamic list; for example, a user may be shown the top 5 or top 10 (or top N) most relevant results, may be shown all relevant results above a particular similarity score, may be able to change the number of results shown, or may otherwise be able to customize the output. This approach might be called a “subject similarity search.”

In another exemplary embodiment, the method may proceed for clustering the data blocks under the given subject. For a collection of data blocks under one subject, the signature and centroid vector might be calculated and characterized for the subject. The similarity of individual data blocks to the centroid can then be measured, in order to determine which blocks are most similar or relevant to the centroid or subject. The blocks that are most similar to the centroid can then be collected as likely to contain the most relevant data.

In another exemplary embodiment, the method may proceed by identifying a topic of the plurality of related data blocks, and generating a plurality of subtopics related to said topic. Then, for each subtopic in the plurality of subtopics, the method may proceed by sampling a portion of the plurality of related data blocks to identify data blocks related to the subtopic; calculating a signature and centroid for the portion of sampled data blocks; calculating, for each data block signature, a similarity value based on the data block centroid; and sorting each data block in the plurality of related data blocks into one or more subtopics based on the similarity value. This may then allow a user to quickly reference the data blocks by the subtopic, and may, for example, be done automatically without a direct user query. Data blocks may be displayed in a ranked order based on their similarity value.

In another exemplary embodiment, the method may proceed by receiving a search query of one or more keywords; calculating a signature and centroid for the portion of sampled data blocks; calculating, for each data block signature, a similarity value based on the data block signature and the centroid; sorting each data block in the plurality of related data blocks into a ranked order based on the similarity value; and identifying one or more data blocks in the plurality of related data blocks having the highest similarity values, and displaying the one or more data blocks with the highest similarity values. The display of the data blocks with the highest similarity values may be, for example, a static or dynamic list; for example, a user may be shown the top 5 or top 10 (or top N) most relevant results, may be shown all relevant results above a particular similarity score, may be able to change the number of results shown, or may otherwise be able to customize the output.

In another exemplary embodiment, the method may proceed by receiving a search query that may be or may refer to a search query data block. Such a method may proceed by calculating a signature and query vector for the search query data block; calculating, for each data block signature and centroid, a similarity value based on the data block centroid; sorting each data block in the plurality of related data blocks into a ranked order based on the similarity value; identifying one or more data blocks in the plurality of related data blocks having the highest similarity values; and displaying the one or more data blocks with the highest similarity values. In some exemplary embodiments, such a method may be available from another search results screen, such that a user may be able to search for more results relevant to a particular data block search result.

In some exemplary embodiments, the plurality of related data blocks may be documents (such as articles) or web contents (such as web pages) and the data segments may be words, with extraneous matter being stop words. In other exemplary embodiments, the plurality of related data blocks may be images, and the data segments may be pixels or colors. In other exemplary embodiments, the plurality of related data blocks may be sounds, and the data segments may be sound attributes, for example pitches, durations, loudnesses/volumes, and timbres.

In an exemplary embodiment, the method may further include processing the data blocks before they are collected into a plurality of related data blocks. For example, a system may perform noise removal to remove data noise, may unify the format of the raw data blocks into a universal format, or may perform space mapping of the raw data blocks.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a flowchart of a method for performing searching.

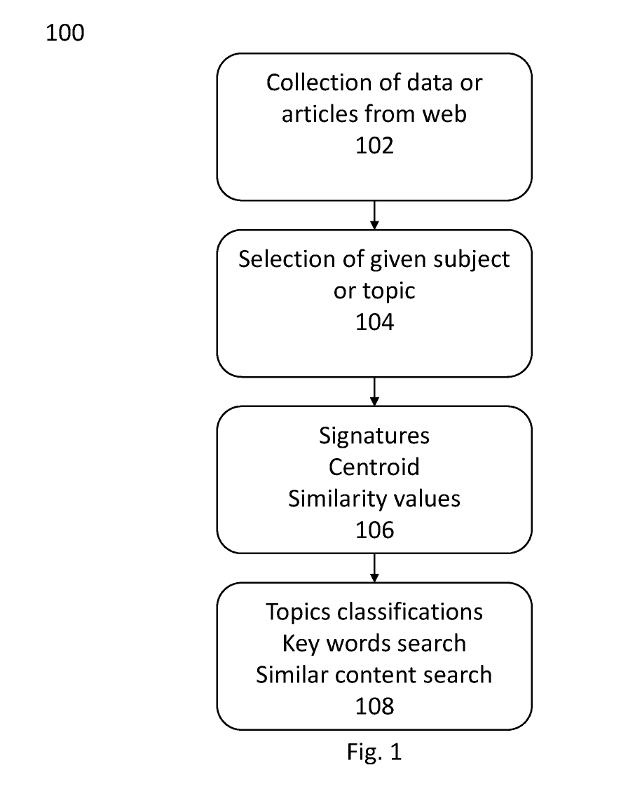

FIG. 2 is an exemplary embodiment of a flowchart of a method for organizing data.

FIG. 3 is an exemplary embodiment of a flowchart of a method of calculating a signature.

FIG. 4 is an exemplary embodiment of the interface of a search engine which may implement the system and method for performing searching.

FIG. 5 is an exemplary embodiment of a search results list that may result from a subject group or key word search.

FIG. 6 is an exemplary embodiment of a search results list that may result from a similar document search.

FIG. 7 is an exemplary embodiment of a user interface for data block display.

FIG. 8 is an exemplary embodiment of a system diagram for a method of performing similarity analysis.

FIG. 9 is an exemplary embodiment of a system diagram for a method of performing key word similarity searching or subject similarity searching.

FIG. 10 is an exemplary embodiment of a vector in N-dimensional space corresponding to a particular word.

FIG. 11 is an exemplary embodiment of a set of frequencies which may be associated with the words found in a particular data block.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a system and method for performing searching by conducting similarity analysis may be disclosed.

According to an exemplary embodiment of an approach for conducting similarity analysis, a large set of related data blocks may be collected. Each of these data blocks may be broken down further into small cells. According to some exemplary embodiments, these cells may be different based on the content of the data block, and a variety of different types of cells may exist. For example, Web pages or other documents may be broken down into word or phrase cells; images or videos may be broken down into pixels, or blocks of pixels, and colors; and music or other sounds may be broken down into cells storing pitches, durations, volume, timbre, and the like. Other types of cells, for these or other types of data, may also be contemplated. In some embodiments, data blocks may be associated with multiple types of cells; for example, according to an exemplary embodiment, a data block corresponding to video may be separated out into cells storing pixels and colors, and into cells storing sound elements.

Once a large number of cells have been calculated, the statistical distribution behaviors of different cells may be studied. In particular, a variety of statistical properties may be evident from the collection of the cells, or the collection of similar data blocks from which the cells are generated. These properties may include, for example, the means and the variance of the cells, or any other properties that may be of interest, as may be desired.

From these statistical properties, a data structure called a signature may be derived. In some embodiments, a signature over a set of data blocks from a particular subject may be calculated. With the assistance of mapping models, through the analysis of large sets of similar data blocks, a signature of a data block can be mapped as a vector in N-dimensional space, which may be called a centroid of a data block.

With a given query vector, or subject centroid, the similarity of individual data blocks to the vector or the centroid can then be measured, in order to determine which blocks are most similar to them. The blocks that are most similar to the vector or the centroid can then be collected as likely to contain the most relevant data.

According to an exemplary embodiment, a centroid for a particular subject may be generated according to the following logic or according to logic similar to the following. In a first step 102, for a given subject, a large collection of data blocks may be assembled from appropriate sources. For example, in some exemplary embodiments, data blocks may include articles, images, sounds, and other data types, as may be desired. Sources may include, for example, web sites, forums, chat logs, or any other appropriate sources, as may be desired.

When a subject has been selected, and a data set for the subject has been assembled, in a next step 104, the data set may be sampled. For example, the data set may be sampled based on a particular subject or topic. In some exemplary embodiments, any method of sampling the data may be used; for example, the data may be sampled by keyword query. This may yield a subset of data. A signature and centroid may then be formed based on this subset of data 106.

In a next step 106, for each data block, a signature may be defined. In an exemplary embodiment, this signature may be formed from cells that appear with a high frequency in the data set, and may include the frequency values of those cells. Based on this sampling of the data set and mapping model, a centroid of the data may be calculated.

In a final step 108, the data may be put into usable form, such that a user can access it. For example, in an exemplary embodiment, one or more topic classifications may be generated for the data, such that a user can search for particular data blocks by topic based on the similarity of those data blocks to a topic centroid. In another exemplary embodiment, a user may perform a keyword search, and data may be provided to the user based on the similarity of the data blocks to the keyword or keywords. In another exemplary embodiment, the user may be able to search for similar content, for example by providing an image and requesting to perform a search for similar images.

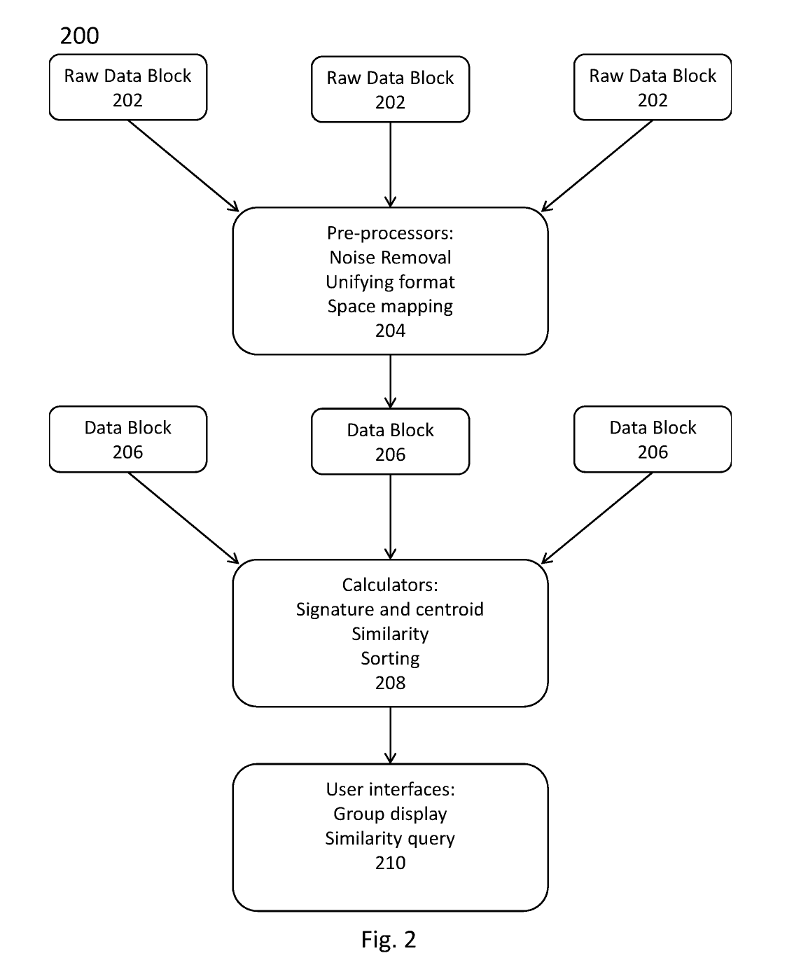

Turning next to exemplary FIG. 2, FIG. 2 may show in more detail a process by which a method and system for performing searches may be performed 200. In a first step, raw data blocks 202 may be provided, which may be pre-processed 204. This may include, for example, performing noise removal to remove data noise, unifying the format of the raw data block into a universal format, and performing space mapping of the raw data block. Space mapping of the raw data block may include, for example, transforming the raw data block by generating a less accurate and less processor-intensive model (a “fast model” or “coarse model”) and enhancing the “coarse model” by comparing it to a more resource-intensive “fine model.”

In a next step, the data blocks 206 that may be produced by the pre-processing step 204 may be provided to a calculator 208, which may calculate a signature for the data block 206, may calculate a centroid, may calculate similarity, and may perform sorting. The resulting information may then be provided to a user interface 210. On such a user interface 210, data may be displayed by groups (for example, by topics as described above) or may be queried (for example, based on similarity to a keyword as described above).

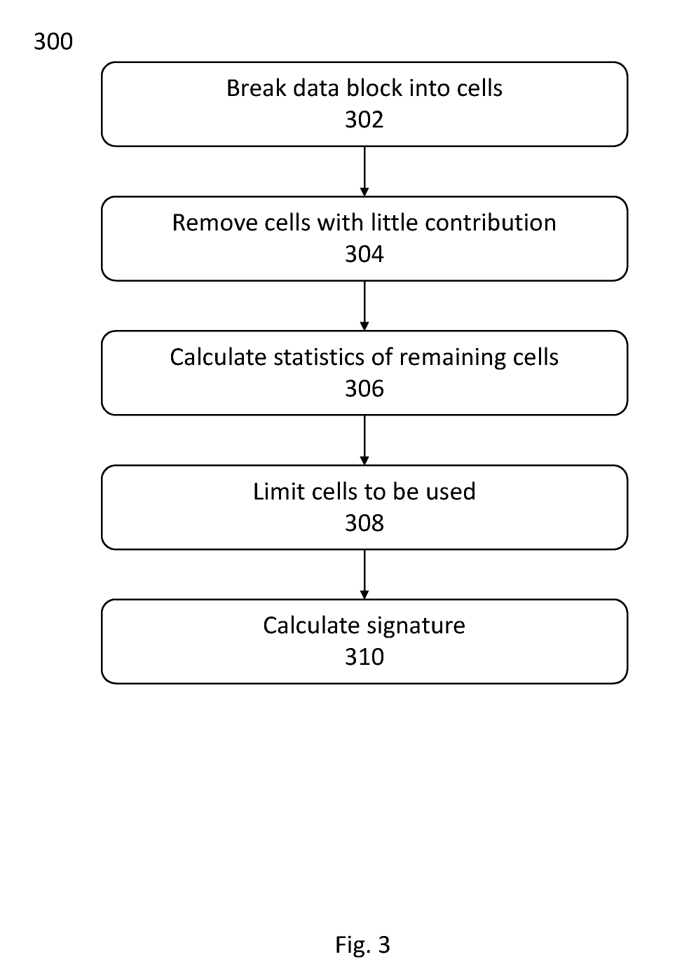

Turning next to exemplary FIG. 3, the steps of calculating a signature 300 may be shown in more detail. A user may first begin with a data block, or with a set of data blocks, such as the data science pages included in the Data Science Hub search engine. The data block or data blocks may be broken into cells (such as, for example, words, pixels, sound components, or the like) 302.

In a next step, some of the cells having a higher occurrence, but which have little to no significance in or contribution to the final subject or to the features of the data block, may be removed 304. These cells may include, for example, stop words or stop characters (such as periods) in written documents, boilerplate language in written documents, certain pixel colors (such as white or black) in images, or any other cells that are considered to have no contribution or little/less contribution to the final subject.

In a next step, one or more statistics may be calculated for the remaining cells 306. These statistics may include, for example, the frequency value for remaining words, phrases, or characters, may include the colors of pixels, or may include any other information, as may be desired.

In a next step, the cells that may be used in the remaining steps may be limited 308. For example, the cells may be limited to a fixed size or number of cells rather than all cells. For example, in some exemplary embodiments, only those cells that are most frequently used (for example, the top N most frequently used cells) may be used, and the rest may be discarded. This may help to facilitate real-time calculation while having minimal impact on the final result, because cells that occur less frequently will have lesser or minimal impact on later similarity checks. In other exemplary embodiments, however, comprehensiveness may take precedence over the speed of calculation, and all cells may be used despite the potential for this to disrupt real-time calculation. (In some exemplary embodiments, the data set size may be so small, or the available processing power may be so large, that real-time calculation may be performed without limiting the cells to a fixed size or number of cells.)

Over time, the size of the collection may grow. As the size of the collection grows, the cells that occur with high frequency, along with the frequency values of those cells, will maintain a minimal variation.

In a last step 310, a signature may be calculated. The signature may include the high-frequency cells, along with the frequencies with which each of the high-frequency cells occurs. In some cases, data blocks may be sampled under a subject, and the resulting subject signature may be, as mentioned, generated based on this sampling. From the signature, its centroid in N-dimensional feature space can be obtained from a mapping model that has been previously trained using a large set of data blocks.

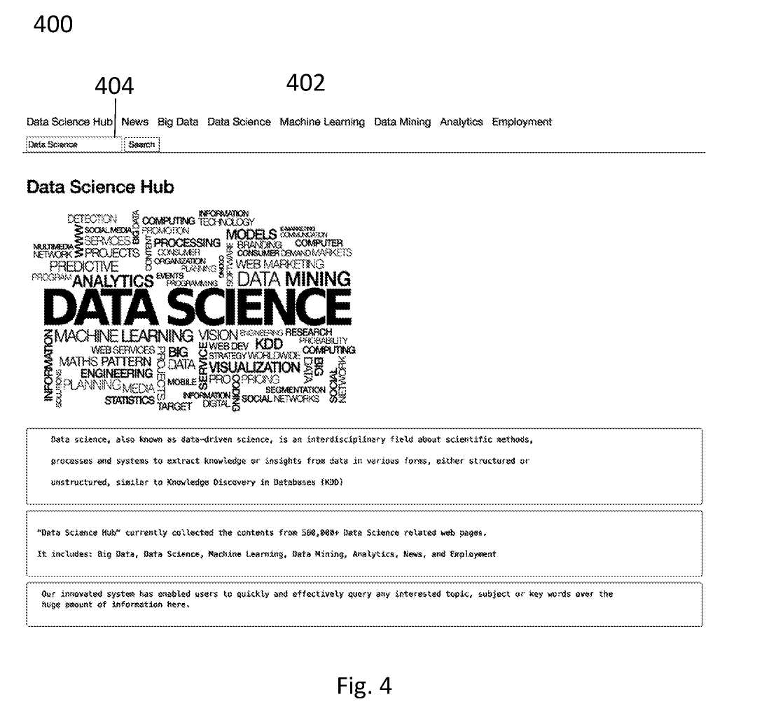

As shown in FIG. 4, one such subject that may be used as the basis for generation of a centroid is “data science.” Specifically, FIG. 4 depicts an exemplary embodiment of a search engine 400, “Data Science Hub,” which may be concerned with the field of data science or one or more subfields within that field. As explained in FIG. 4, data science, also known as data-driven science, may be defined as an interdisciplinary field about scientific methods, processes, and systems to extract knowledge or insights from data in various forms, either structured or unstructured. For example, one such application of the data science field may be the field of Knowledge Discovery in Databases (KDD).

As described in exemplary FIG. 4, the search engine 400 may include the content from 560,000 or more data science-related web pages. Subfields within the field of data science may include “big data,” general data science, machine learning, data mining, analytics, news, and employment opportunities within the field. Other subfields may of course be contemplated. The search engine may provide users with an option to search directly 404 and may provide users with an option to explore particular subfields 402.

Based on the content of the search engine 400, a user may proceed through the steps of calculating a signature, as shown in exemplary FIG. 3, in order to calculate a centroid for the subject of “data science.” The results of such a signature calculation, based on the over 560,000 articles from data science related web sites available on the search engine, may be shown in table 1, as follows.

TABLE 1
Signatures of words and frequencies for the subject
“Data Science.”

| Words | Frequencies |
|---|---|
| Data | 0.2299323 |
| Analytics | 0.120569 |
| Big | 0.093221 |
| Science | 0.039897 |
| . . . | . . . |
| Performance | 0.00704298 |

Once a signature and centroid have been assigned to each data block, and a query vector or a subject centroid has been generated, the distance of the centroid of the data block to the query vector or centroid may be calculated. This may be done by, for example, calculating a cosine similarity value of the two vectors, or by using another vector comparison technique, as may be desired.

To briefly discuss cosine similarity, cosine similarity is a measure of calculating the similarity of two vectors, specifically two non-zero vectors of an inner product space. The vectors are compared by measurement of the cosine between them. The cosine of zero degrees (with this indicating vectors extending in the same direction) is 1, and the cosine of any other angle is less than 1. As such, the similarity of the two vectors can be quantified by determining what the cosine of the angle between them is, with cosine values very close to 1 indicating very similar orientations and cosine values further away from 1 indicating more different orientations. Evaluating the cosine between two vectors in order to determine their similarity may be efficient to evaluate, and thus desirable.

A plurality of user cases that may be reflective of one or more exemplary embodiments may next be discussed. Each user case may indicate, for example, one or more actions that can be performed on a properly-configured data set.

In a first user case, it may be desired to classify a particular data set into one or more topics. For example, it may be desired to break down the subject of “data science” into one or more subtopics to allow for easier searching and analysis. Example subtopics into which this subject may be broken include, for example, “machine learning,” “big data,” “data mining,” “analytics,” and “employment.” In such a case, a centroid may be calculated for each of the subtopics, and data blocks may be sorted based on the similarity of each data block to each of the topic centroids. In an exemplary embodiment, the blocks may be classified based on the highest similarity score; in an alternative exemplary embodiment, the blocks may be classified based on whether the similarity scores of the blocks pass a certain threshold, and blocks may have two or more subtopics associated with them.

In a second user case, it may be desirable to, given a keyword or keyphrase, find the most significant data block or data blocks having to do with that keyword or keyphrase. For example, a user may input a keyword query in order to identify search results having to do with that keyword query. From the given query, a query vector may be calculated using the previously built mapping mode. The similarities of individual data blocks to this query vector may be calculated. The user may then be presented with the data that has the most similarities to the query vector, and which should thus be most relevant to answering the query (or among the most relevant data for doing so).

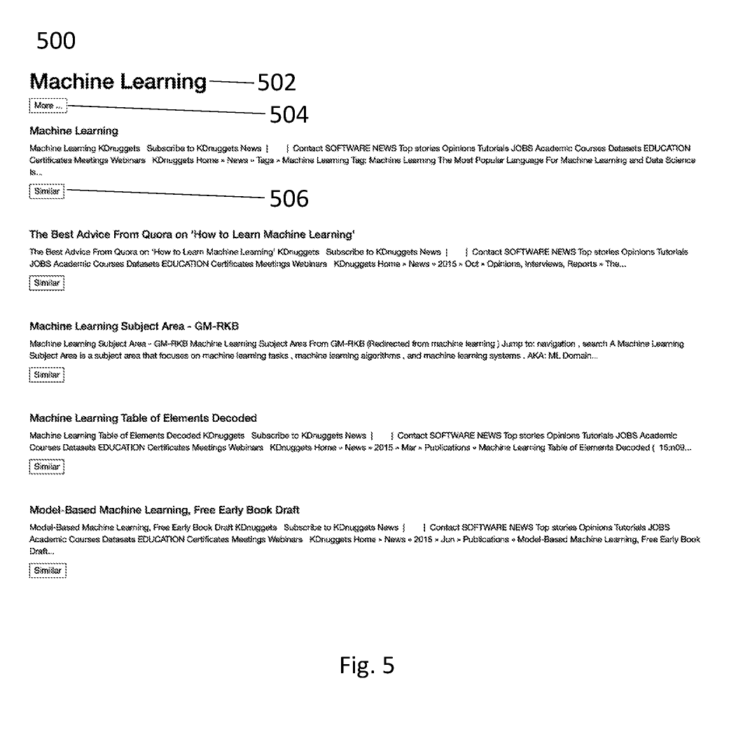

An example of either of the first user case or the second user case may be shown in exemplary FIG. 5. FIG. 5 displays an exemplary embodiment of a subject group or key word search 500 for “machine learning” 502; “machine learning” may be a subtopic as in the first user case or may be the search query of a user as in the second user case. The interface may display a plurality of results, with the option to display additional results 504 if the user determines that none of the results displayed by the search were relevant or otherwise wishes to see more results than what is provided. In an exemplary embodiment, by default, the results that are determined to be most similar may be displayed first, and may optionally be presented along with a similarity score such that the user can judge the similarity of the results to the query. (This may, for example, allow the user to determine what results are most worth looking at, and if it is worth extending the search results to other results of less relevance 504.)

As shown in FIG. 5, a user may, from the search results page, be able to target individual data blocks in the search results and use them as the starting point for further searching. That is, a user may, for a given data block, be able to select to identify similar search results to that data block 506. This may be discussed in more detail in a third user case.

In a third user case, it may be desirable to, given a data block, find data blocks that are similar. In an exemplary embodiment, the starting data block and the similar data blocks may each be, for example, an article or other text document, an image or video, a sound, or any other type of data block as may be desired. In an exemplary embodiment, the starting data block and the similar data blocks may be different types of data blocks; for example, sound cells may be generated from a video data block to facilitate the comparison of the video data block to sound data blocks. In order to perform such a search, the starting data block may be used to generate a centroid to the search query. The remaining data blocks may be compared to this centroid in order to determine which of these data blocks are most similar to the starting data block.

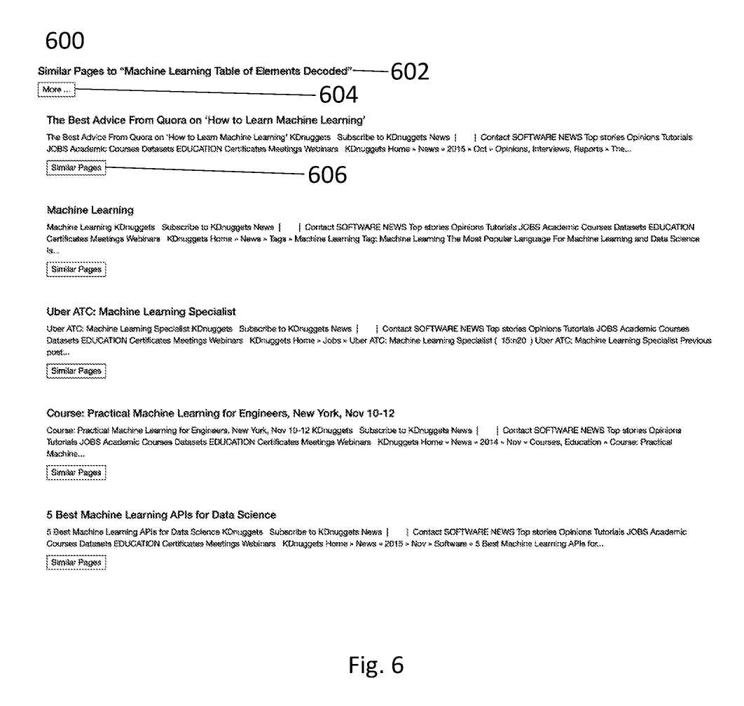

An example of the third user case may be shown in exemplary FIG. 6. FIG. 6 displays an exemplary embodiment of a similar document search 600; specifically, in the similar document search 600 described in FIG. 6, a user may have searched for pages that are similar to one of the search results shown in FIG. 5, which is entitled “Machine Learning Table of Elements Decoded” 602. As before, a user may have the option to extend the search results to see additional search results other than the most relevant results displayed 604, and may have the option to view pages that are similar 606 to one of the search results of the similar document search 600.

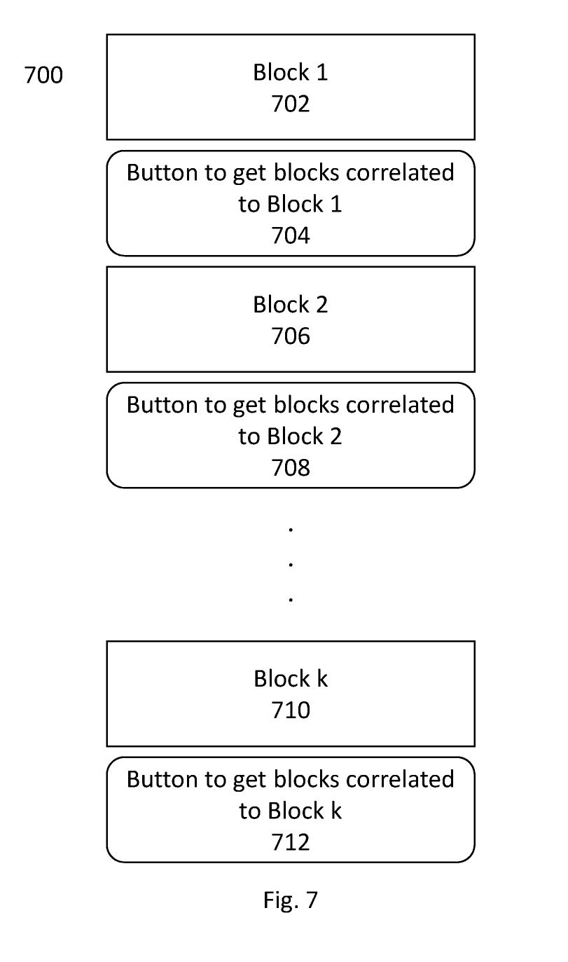

A general interface may be shown in exemplary FIG. 7. FIG. 7 displays an exemplary embodiment of an interface 700 that may be applied to any kind of search result, including, for example, documents or other written search results, images or other visual search results, or sounds or other audio search results. Blocks, such as blocks from block 1 702 to block k 710, may be paired with a button that may allow the user to retrieve blocks that are similar to the block with which the button is paired. For example, block 1 702 may be paired with a first button 704 configured to request a search for blocks correlated to block 1 702, block 2 706 may be paired with a second button 706 configured to request a search for blocks correlated to block 2 708, and so forth until the last block 710 and last button 712 on the list. In an exemplary embodiment, a set amount of search results may be retrieved; in another exemplary embodiment, all search results over a certain similarity threshold value may be shown; and in another exemplary embodiment, any number of search results may be shown, as desired.

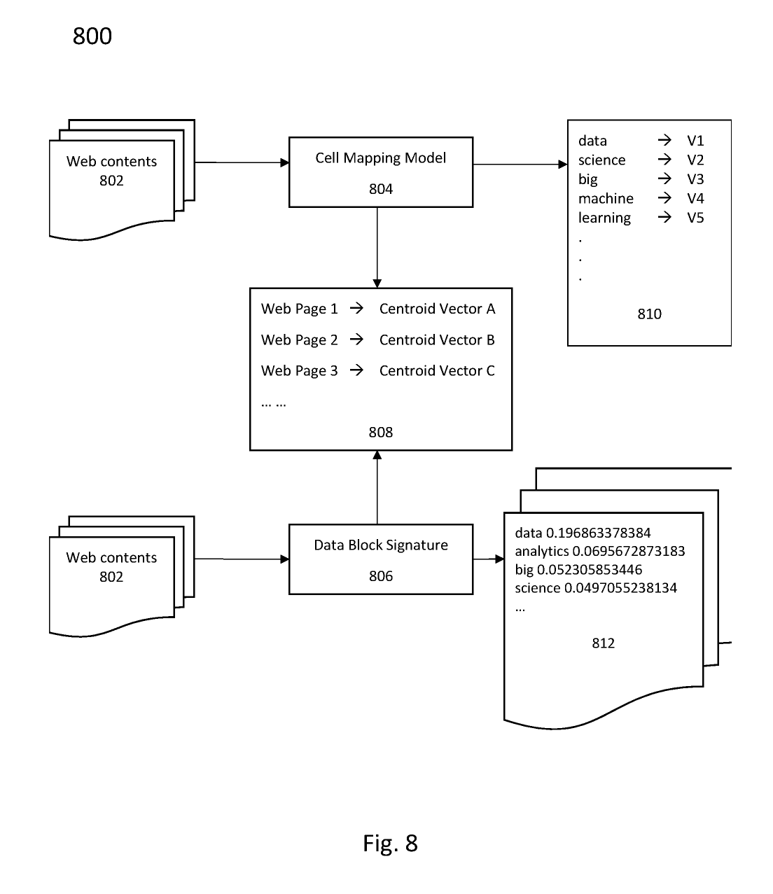

Turning now to exemplary FIG. 8, FIG. 8 may show an exemplary embodiment of a system diagram for a method of performing similarity analysis 800.

In a first step, the system may harvest web contents 802 in order to collect a plurality of data blocks. In an exemplary embodiment of a typical application, the system may collect a relatively large number of data blocks, for example 200,000 or more data blocks, from web content 802 of at least one type, including documents, audio content, image/video content, or other types.

In a next step, the system may train a model to map cells of a data block to vectors in N-dimensional feature space 804. These cells may be, for example, words (if the data blocks include documents/text content), or any other cell types (if the data blocks include other types of content).

An exemplary technique that may be used in order to train the model to map cells of data blocks may be the use of WORD2VEC modeling. In WORD2VEC modeling, words may be represented as vector representations of those words, called “word embeddings.”

To provide some background about WORD2VEC modeling, it can be compared to other natural language processing systems. Typical natural language processing systems treat words as being discrete atomic symbols; a first word, such as “cat,” may be represented by a first data string, and a second word, such as “dog,” may be represented by a second data string. No useful information may be provided to the system regarding what relationships exist between the underlying concepts of “cat” and “dog.” This means that the system does not have a built-in way to leverage any of the information that has been processed about “cats” when processing data about “dogs,” such as that each is a common household pet.

Vector space models (VSM), on the other hand, represent words in a continuous vector space. In this vector space, semantically similar words are mapped to nearby points, and vectors are then generated to store information about how the word relates to other words. In “count-based” methods, vectors are generated based on statistics of how often a word co-occurs with its neighbor words in a large body of text. In “predictive” methods, predictive models try to predict a word from its neighbors based on small, dense “embedding vectors” that have been learned by the model. WORD2VEC, in particular, is a computationally-efficient predictive model.

Alternatively, any other technique or combination of techniques other than WORD2VEC, such as any other vector space model or any other technique for generating a vector, may be used to map cells to vectors, as may be desired.

According to an exemplary embodiment, the data set that may be used to train the model may be a selection of cells from the data blocks collected. In an exemplary embodiment, the number of cells used to train the data set may be in the same order of magnitude as the number of data blocks collected (for example, in an exemplary embodiment, 560,000 cells may be used to train the mode); in another exemplary embodiment, more or fewer cells may be used, as desired.

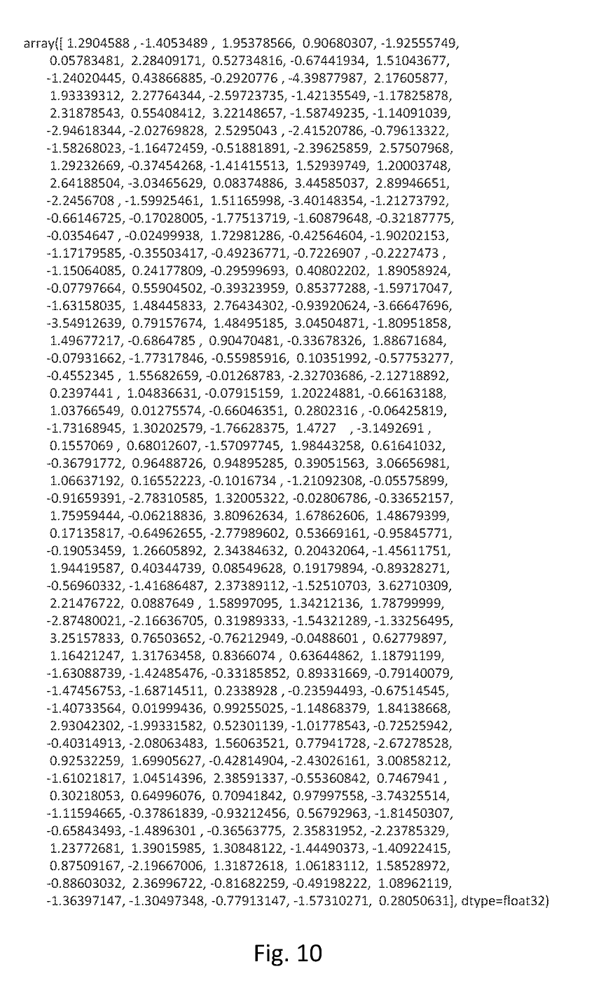

In a next step, the model may define particular words as vectors 810. For example, the word “data” may be defined as a first vector V1, the word “science” may be defined as a second vector V2, the word “big” may be defined as a third vector V3, and so on and so forth as depicted in step 810. Vectors may be of arbitrary size; for example, in an exemplary embodiment, the word “data” may be defined as a 250-dimension vector as depicted in FIG. 10.

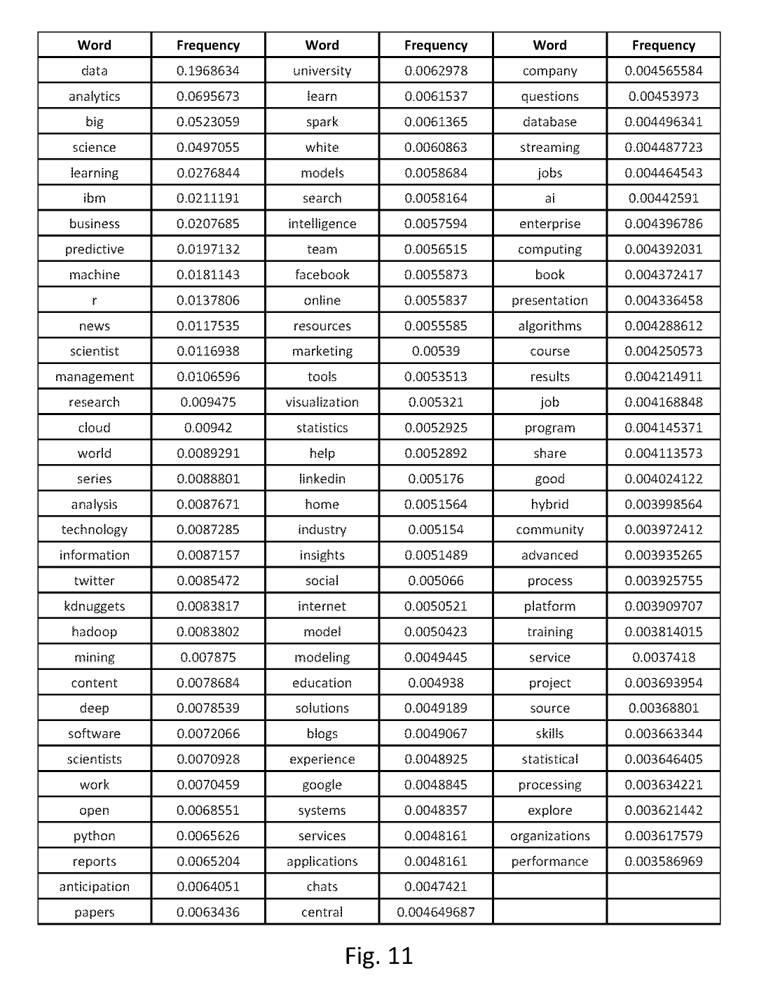

In a next step, for each data block or document that makes up a part of the retrieved web contents, a data block signature 806 may be calculated. In some exemplary embodiments, this step may be performed before, after, or in parallel with cell mapping or vector generation, as desired, as performance of this step may not be dependent on the results of the cell mapping 804 or vector generation 810 operations. In an exemplary embodiment, the signature of each data block or document may be generated by counting the top-N number of cells or top-N number of words in the data block or document, and then, based on that value, calculating the frequencies 812. An exemplary embodiment of a list of frequencies that may be associated with a particular data set may be shown in FIG. 11.

In a next step 808, for each cell or word in the data block, and for each document signature, the map model generated in step 804 may be used in order to map the cell, word, or document signature to the N-dimensional feature space. These vectors in N-dimensional feature space may then be weighted by the frequency with which the word appears in the data block or document, and may be summed, in order to yield a centroid vector for the data block. This may take the form of the following equation:

Centroid=ΣVₖ*Fₖ,

wherein Vₖ is a vector in N-dimensional feature space that represents the contents of a particular cell (such as, for example, a word), and Fₖ is the frequency with which those contents (such as the particular word in question) appears in the data block. The centroid may be the sum of a particular number of the products of vector and frequency pairings, this number being represented by k, such that the centroid is the sum of the products of vector and frequency pairings from V₁*F₁ to Vₖ*Fₖ. This may be repeated for each of the data blocks in the collection of data blocks, such that each of the collected data blocks (in an exemplary embodiment, all 200,000+) has a centroid associated with it.

Once these centroid values have been assembled for the data blocks, it may be desired to search the data blocks or documents with a particular query. For example, in an exemplary embodiment, a user may desire to search the collection of data blocks for the term “data science.” In an exemplary embodiment, for this query, a query vector may be generated by mapping “data” and “science” to two vectors in N-dimensional space, and then adding them together with equal weights. (However, in some exemplary embodiments, the elements of a search query may be provided with unequal weights. In some exemplary embodiments, this may be done automatically. In some exemplary embodiments, this may be customizable by the user performing the search, who may be able to specify, for example, that a term has a higher-than-normal weight, lower-than-normal weight, a particular weight which the user may customize, or another weight, as desired.

To perform the search according to the query, according to an exemplary embodiment, the system may then be configured to calculate the similarity or distance between the query and the data blocks or documents in the collection of data blocks or documents. This may yield the data blocks which most closely match the query.

According to an exemplary embodiment, once a collection of data blocks has been analyzed, additional data blocks may be added to it. For example, a particular collection of data blocks may be a collection of documents relevant to a particular subject area (such as data science) and new articles may be periodically published in the subject area and added to the collection. When an additional data block is added to the collection, according to an exemplary embodiment, the system may measure the distance between the new data block and any or all of the existing data blocks, which may improve the ability of the system to classify the new data block.

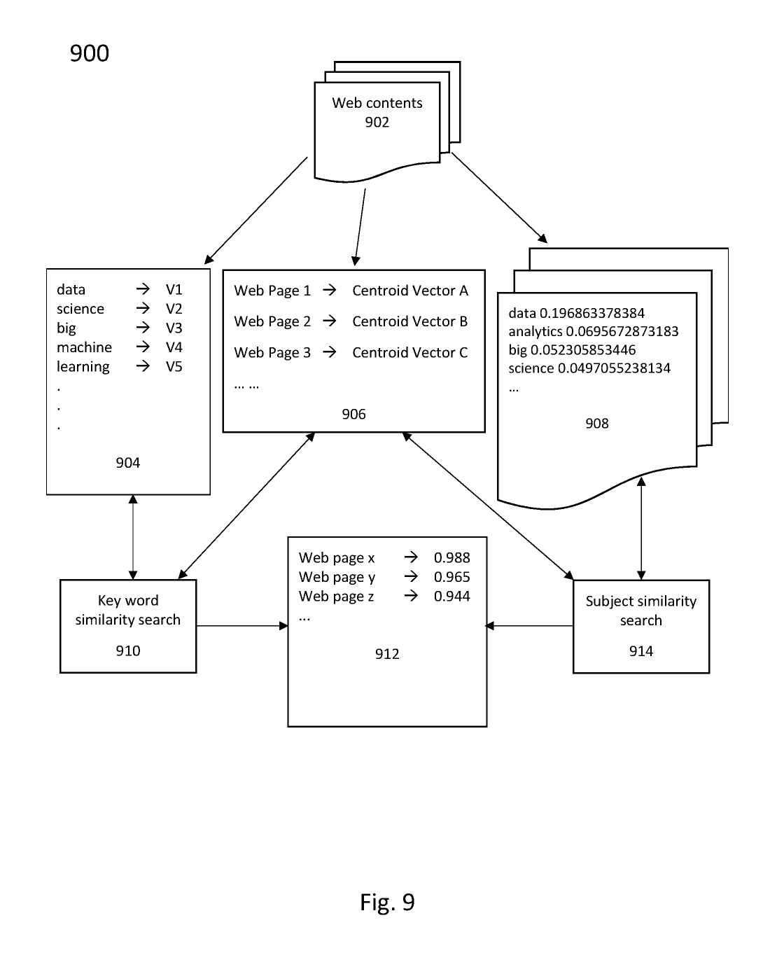

Turning now to exemplary FIG. 9, FIG. 9 may show an exemplary embodiment of a system diagram for a method of performing key word similarity searching or subject similarity searching 900.

In a first step, the system may harvest web contents 902 or other data in order to collect a plurality of data blocks. In a next step, the system may perform vector generation operations 904, may calculate a plurality of centroid vectors 906, and may calculate a plurality of frequencies 908. In an exemplary embodiment, these operations may be performed substantially as described in FIG. 8, or may be otherwise performed, as may be desired.

The system may then perform either a key word similarity search 910 or a subject similarity search 914. In a key word similarity search, the system may compare one or more vectors to the calculated centroid vectors 906; for example, in an exemplary embodiment, the system may access and may compare the vectors generated by the vector generation operations 904 to the centroid vectors 906. In a subject similarity search 914, the system may instead calculate search results based on the centroid data 906 and based on frequency data 908.

In an exemplary embodiment, once the key word similarity search 910 or the subject similarity search 914 has been performed, a list of search results 912 may be generated. These search results 912 may be, for example, a list of web pages, which may be generated in ranked order based on their similarity to a query vector input in the key word similarity search 910 or based on their similarity to a subject centroid generated as part of the subject similarity search 914. For example, according to an exemplary embodiment, a cosine similarity value may be generated for each searched item (for example, a first web page x, a second web page y, a third web page z, and so forth) and the searched items may be ranked by cosine similarity (for example, a first web page x may have a calculated cosine similarity value of 0.988, a second web page y may have a calculated cosine similarity value of 0.965, a third web page z may have a calculated cosine similarity value of 0.944, and so forth). In some exemplary embodiments, cosine similarity values may be directly shown to a user, and in some exemplary embodiments, users may be able to select alternative sorting methods for the data, if desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for performing searching by top-to-bottom similarity analysis, comprising:
collecting a plurality of related data blocks;
breaking each of the plurality of related data blocks into a plurality of cells, each cell comprising a data segment;
training a model to map the cells in the plurality of cells to a plurality of vectors in N-dimensional feature space, and mapping each cell in the plurality of cells to a vector in the plurality of vectors;
calculating a signature for each data block, the signature comprising a plurality of frequency values for a plurality of data segments in the data block, the plurality of data segments comprising at least one of a predefined number of data segments or a number of data segments falling above a frequency threshold;
pairing, for each data block in the plurality of related data blocks, the vectors in the plurality of vectors with the respective frequency values in the plurality of frequency values;
calculating, for each data block in the plurality of related data blocks, a data block centroid based on the equation Centroid=ΣVₖ*Fₖ, wherein Vₖ is a vector in the plurality of vectors, Fₖ is a frequency in the plurality of frequencies that is paired with Vₖ, and k is a number of vectors and frequencies used to generate the data block centroid;
associating the data block centroid with the data block and storing the data block centroid in a memory.

2. The method of claim 1, further comprising:
before the step of training a model, identifying one or more undesirable cells, the undesirable cells comprising cells having a high occurrence, the undesirable cells further comprising at least one of cells having a low amount of contribution to a final subject or cells comprising a data block feature; and
removing the one or more undesirable cells from the plurality of cells.

3. The method of claim 1, further comprising:
sampling a portion of the plurality of related data blocks, the portion of sampled data blocks comprising data blocks related to a subject;
calculating a signature for the portion of sampled data blocks, and designating said signature as a centroid of the subject;
associating the centroid of the subject with the subject and storing the centroid of the subject in the memory;
calculating, for each data block centroid, a similarity value based on the data block centroid and the centroid of the subject; and
storing the similarity value in the memory.

4. The method of claim 1, further comprising:
identifying a topic of the plurality of related data blocks, and generating a plurality of subtopics related to said topic;
for each subtopic in the plurality of subtopics, sampling a portion of the plurality of related data blocks, the portion of sampled data blocks comprising data blocks related to the subtopic;
calculating a signature for the portion of sampled data blocks, and designating said signature as a centroid of the subtopic;
calculating, for each data block centroid, a similarity value based on the data block centroid and the centroid of the subtopic; and
sorting each data block in the plurality of related data blocks into one or more subtopics based on the similarity value.

5. The method of claim 3, further comprising displaying, on a user interface, a list of data blocks associated with a subtopic in the plurality of subtopics, the list of data blocks displayed in a ranked order based on the similarity value of each data block.

6. The method of claim 1, further comprising:
receiving a search query comprising one or more keywords;
sampling a portion of the plurality of related data blocks based on the search query;
calculating a signature for the portion of sampled data blocks, and designating said signature as a centroid of the search query;
calculating, for each data block centroid, a similarity value based on the data block centroid and the centroid of the search query;
sorting each data block in the plurality of related data blocks into a ranked order based on the similarity value; and
identifying one or more data blocks in the plurality of related data blocks having the highest similarity values, and displaying the one or more data blocks.

7. The method of claim 1, further comprising:
receiving a search query comprising a search query data block;
calculating a signature for the search query data block, and designating said signature as a centroid of the search query;
calculating, for each data block signature, a similarity value based on the data block centroid and the centroid of the search query;
sorting each data block in the plurality of related data blocks into a ranked order based on the similarity value; and
identifying one or more data blocks in the plurality of related data blocks having the highest similarity values, and displaying the one or more data blocks.

8. The method of claim 1, wherein the plurality of related data blocks comprise documents, the data segments of the plurality of cells comprise words, and the data segments of the one or more undesirable cells comprise stop words.

9. The method of claim 1, wherein the plurality of related data blocks comprise images, and the data segments of the plurality of cells comprise at least one of pixels or colors.

10. The method of claim 1, wherein the plurality of related data blocks comprise sounds, and the data segments of the plurality of cells comprise at least one of pitches, durations, loudnesses, and timbres.

11. The method of claim 1, wherein the step of collecting a plurality of related data blocks comprises processing a plurality of raw data blocks, the step of processing comprising at least one of: performing noise removal to remove data noise, unifying the format of the raw data blocks into a universal format, or performing space mapping of the raw data blocks.

12. A system for performing searching by top-to-bottom similarity analysis, the system comprising a processor and a non-transitory computer-readable medium comprising program code that, when executed, causes the processor to execute steps comprising:
collecting a plurality of related data blocks;
breaking each of the plurality of related data blocks into a plurality of cells, each cell comprising a data segment;
training a model to map the cells in the plurality of cells to a plurality of vectors in N-dimensional feature space, and mapping each cell in the plurality of cells to a vector in the plurality of vectors;
calculating a signature for each data block, the signature comprising a plurality of frequency values for a plurality of data segments in the data block, the plurality of data segments comprising at least one of a predefined number of data segments or a number of data segments falling above a frequency threshold;
pairing, for each data block in the plurality of related data blocks, the vectors in the plurality of vectors with the respective frequency values in the plurality of frequency values;
calculating, for each data block in the plurality of related data blocks, a data block centroid based on the equation Centroid=ΣVₖ*Fₖ, wherein Vₖ is a vector in the plurality of vectors, Fₖ is a frequency in the plurality of frequencies that is paired with Vₖ, and k is a number of vectors and frequencies used to generate the data block centroid;
associating the data block centroid with the data block and storing the data block centroid in the memory.

13. The system of claim 12, further comprising instructions to perform steps comprising:
before the step of training a model, identifying one or more undesirable cells, the undesirable cells comprising cells having a high occurrence, the undesirable cells further comprising at least one of cells having a low amount of contribution to a final subject or cells comprising a data block feature; and
removing the one or more undesirable cells from the plurality of cells.

14. The system of claim 12, further comprising instructions to perform steps comprising:
sampling a portion of the plurality of related data blocks, the portion of sampled data blocks comprising data blocks related to a subject;
calculating a signature for the portion of sampled data blocks, and mapping the signature to a centroid;
generating one of a query vector or a subject centroid, the step of generating a subject centroid further comprising associating the subject centroid with the subject and storing the subject centroid in the memory;
calculating, for each data block centroid, a similarity value based on the data block centroid and the query vector or subject centroid; and
storing the similarity value in the memory.

15. The system of claim 12, further comprising instructions to perform steps comprising:
identifying a topic of the plurality of related data blocks, and generating a plurality of subtopics related to said topic;
for each subtopic in the plurality of subtopics, sampling a portion of the plurality of related data blocks, the portion of sampled data blocks comprising data blocks related to the subtopic;
calculating a signature for the portion of sampled data blocks, and designating said signature as a centroid of the subtopic;
calculating, for each data block centroid, a similarity value based on the data block centroid and the centroid of the subtopic; and
sorting each data block in the plurality of related data blocks into one or more subtopics based on the similarity value.

16. The system of claim 12, further comprising instructions to perform steps comprising:
receiving a search query comprising one or more keywords;
sampling a portion of the plurality of related data blocks based on the search query;
calculating a signature for the portion of sampled data blocks, and designating said signature as a centroid of the search query;
calculating, for each data block centroid, a similarity value based on the data block centroid and the centroid of the search query;
sorting each data block in the plurality of related data blocks into a ranked order based on the similarity value; and
identifying one or more data blocks in the plurality of related data blocks having the highest similarity values, and displaying the one or more data blocks.

17. The system of claim 12, further comprising instructions to perform steps comprising:
receiving a search query comprising a search query data block;
calculating a signature for the search query data block, and designating said signature as a centroid of the search query;
calculating, for each data block signature, a similarity value based on the data block centroid and the centroid of the search query;
sorting each data block in the plurality of related data blocks into a ranked order based on the similarity value; and
identifying one or more data blocks in the plurality of related data blocks having the highest similarity values, and displaying the one or more data blocks.

18. The system of claim 12, wherein the step of collecting a plurality of related data blocks comprises processing a plurality of raw data blocks, the step of processing comprising at least one of: performing noise removal to remove data noise, unifying the format of the raw data blocks into a universal format, or performing space mapping of the raw data blocks.

19. The system of claim 12, wherein the system is further configured to perform the steps of:
identifying a comparison vector, the comparison vector comprising one of a query vector generated from a search query or a centroid generated from a subject;
sorting the plurality of related data blocks into a sorted list of data blocks, based on at least one of a calculated similarity value or a distance value in feature space between the comparison vector and each data block centroid; and
displaying, on a user interface, the sorted list of data blocks.

20. The system of claim 14, further comprising instructions to perform steps comprising:
performing one of: a similarity key word search using the query vector, the query vector comprising a key word query vector; or a similarity subject search using the subject centroid.
